(19) United States
(12) Patent Application Publication
(10) Pub. No.: US 2022/0358300 A1
(43) Pub. Date: Nov. 10, 2022

(54) ZONE ANTENNA SYSTEM

(71) Applicant: Ecolab USA Inc., St.Paul, MN (US)

(72) Inventor: David L. Snodgrass, Stuart, FL (US)

(21) Appl. No.: 17/662,333

(22) Filed: May 6, 2022

Related U.S. Application Data
(60) Provisional application No. 63/185,380, filed on May 7, 2021.
(60) Provisional application No. 63/197,830, filed on Jun. 7, 2021.

(51) Int. Cl. G06K 7/10; H01Q 7/00; H01Q 9/04; H04B 5/00

(52) U.S. Cl. CPC G06K 7/10366; H01Q 7/00; H01Q 9/0414; H04B 5/0062

(57) ABSTRACT

A zone antenna system includes a zone antenna mat including a substantially planar zone antenna and a zone beacon unit configured to establish a detection zone and detect presence of an electronic tag in the detection zone. The zone antenna system may form part of a compliance monitoring system in which presence of the electronic tag the detection zone is part of a monitored process. The zone antenna system establishes a detection zone, detects entry of one or more electronic tags into the detection zone, and stores and/or wirelessly transmits entry event data corresponding to one or more detected entry events for receipt by a remote or local computing device.

This application claims the benefit of U.S. Provisional Patent Application No. 63/185,380, filed May 7, 2021, and claims the benefit of U.S. Provisional Patent Application No. 63/197,830, filed Jun. 7, 2021, each of which is incorporated by reference herein in its entirety.

### TECHNICAL FIELD

The disclosure relates to compliance systems, and more specifically to antenna systems.

### BACKGROUND

Hospital acquired infections (HAIs) are those infections occurring in a patient during the process of care in a hospital or other health care facility which was not present or incubating at the time of admission. Although the majority of HAIs are considered preventable, thousands of people around the world die every day from infections acquired while receiving health care. Hand hygiene is a simple, low-cost and effective infection prevention and control measure to reduce pathogen transmission in health care and other settings. Despite this, compliance with proper hand hygiene procedures remains low, and improvement efforts tend to lack sustainability.

### SUMMARY

In general, the disclosure relates to a zone antenna system that generates a wireless detection zone and communicates with one or more electronic tags present within the detection zone. In accordance with one or more techniques of the disclosure, the disclosure describes a zone antenna system including a zone antenna and a zone beacon unit configured to establish a wireless detection zone, detect entry of an electronic tag into the detection zone, and store and/or wirelessly transmit entry event data corresponding to the detected entry events.

In one example, the disclosure is directed to an antenna mat comprising a first substantially planar substrate; a second substantially planar substrate; and an antenna layer disposed between the first and second substantially planar substrates and configured to transmit a near-field radio frequency detection zone message and generate a corresponding detection zone, the antenna layer comprising a substantially planar antenna comprised of one or more layers of conductive ink.

In another example, the disclosure is directed to an antenna system comprising an antenna mat comprising: a first substantially planar substrate; a second substantially planar substrate; and an antenna layer disposed between the first and second substantially planar substrates and configured to transmit a near-field radio frequency detection zone message, the antenna layer comprising a substantially planar antenna layer comprised of one or more layers of conductive ink; and a zone beacon unit configured to drive the antenna layer to transmit the near-field radio frequency detection zone message and generate a corresponding detection zone.

The details of one or more examples are set forth in the accompanying drawings and the description below. Other features and advantages will be apparent from the description and drawings, and from the claims.

### BRIEF DESCRIPTION OF DRAWINGS

FIG. 1 is a diagram of an example zone antenna system, in accordance with one or more techniques of the disclosure.

FIG. 2A is a diagram of an example compliance monitoring environment including a zone antenna system, in accordance with one or more techniques of the disclosure.

FIG. 2B is a diagram of another example compliance monitoring environment including a zone antenna system, in accordance with one or more techniques of the disclosure.

FIG. 2C is a diagram of an example compliance monitoring environment including a including a zone antenna mat having an embedded zone antenna and a zone antenna unit, in accordance with one or more techniques of the disclosure.

FIG. 3A is a top perspective view of an example zone antenna mat, in accordance with one or more techniques of the disclosure.

FIG. 3B is another perspective view of the example zone antenna mat of FIG. 3A.

FIG. 3C is a cross-sectional view of the example zone antenna mat of FIG. 3A taken along the line A-A′.

FIG. 3D is a diagram of an example zone antenna coil, in accordance with one or more techniques of the disclosure.

FIG. 4A is a graph showing ranges measured for several example zone antennas, in accordance with one or more techniques of the disclosure.

FIG. 4B is a graph showing example range measurements for an example zone antenna, in accordance with one or more techniques of the disclosure.

FIG. 5 is a block diagram of an example zone antenna and an example zone beacon unit, in accordance with one or more techniques of the disclosure.

FIG. 6 is a flowchart illustrating an example process by which a zone antenna beacon unit may detect entry of an electronic tag into a detection zone, in accordance with one or more techniques of the disclosure.

FIGS. 7A-7C show example zone antenna layers in accordance with one or more techniques of the disclosure.

FIGS. 8A-8D show example zone antenna mats in accordance with one or more techniques of the disclosure.

FIG. 9A is a block diagram of another example zone antenna system in accordance with one or more techniques of the disclosure.

FIGS. 9B and 9C show an example dampening circuit in accordance with one or more techniques of the disclosure.

### DETAILED DESCRIPTION

Monitoring presence of persons or objects within a defined area or zone is one parameter that can be used to monitor compliance with certain business practices, determine the locations of persons, objects or equipment, for security purposes, and for many other applications. For example, staff compliance with proper hand hygiene procedures may be monitored to reduce pathogen transmission in healthcare, food industry, and other settings. In such examples, monitoring of healthcare worker interactions with patients in combination with the hand hygiene practices of those workers plays a role in monitoring compliance with hand hygiene procedures at a healthcare facility.

Existing hand hygiene compliance systems may include control electronics and an antenna that are designed for attachment to a patient bed and to set up a detection zone around the bed, and thus around the patient. However, such systems can be a disadvantage when used with mobile patient transport devices such as stretchers. For example, the attached electronics/antenna move along with the stretcher as it moves throughout the facility, and often remain “on” during transport. This can result in unintentional triggering of zone entry events while moving around the facility or while parked in a hallway or other common area. In addition, such systems require the control electronics/antenna to be “portable” and thus battery powered as it moves around the hospital with the patient bed. This further results in the need to replace batteries in many devices located through a hospital or other healthcare facility, which is time consuming and labor intensive. It also results in the risk that batteries will deplete to the extent that no detection zone is generated. In addition, with the control electronics/antenna being mounted to the patient bed, the size of the embedded antenna is limited, thus limiting the range of the detection zone and rendering it more susceptible to the limiting effects of mounting location and environmental noise. These factors, and the variation in actual mounting location, can also result in uncertainty as to where the detection zone is actually located, and inconsistency in the size of the detection zone. Similar disadvantages are faced by electronics/antennas used to generate detection zones in and around other locations within a healthcare facility, restaurant, food processing facility in other applications where monitoring presence of persons and/or objects within a zone is desired.

In accordance with one or more techniques of the disclosure, the disclosure describes a zone antenna system including a zone antenna and a zone beacon unit configured to establish a wireless detection zone, detect entry of an electronic tag into the detection zone, and store and/or wirelessly transmit entry event data corresponding to the detected entry events.

The zone antenna includes a substantially planar antenna mat having a low or thin profile (e.g., on the order of 0.1 inches (2.54 millimeters) in height) and configured to be mounted or positioned substantially flat against a surface at a physical location where it is desired to set up a detection zone. In a hand hygiene compliance example, the zone antenna mat may be temporarily or semi-permanently mounted or positioned substantially flat on the floor under a patient bed to establish a detection zone around a patient. In another example, the zone antenna mat may be mounted substantially flat against a wall or other vertical or non-horizontal substrate.

The antenna mat includes a substantially planar top substrate, a substantially planar bottom substrate, and a zone antenna layer embedded between the top substrate and the bottom substrate. In some examples, the bottom substrate may include an adhesive layer that enables the antenna mat to be semi-permanently mounted to a floor, a wall, or other substrate. In other examples, the bottom substrate may include a synthetic rubber or other non-slip material that prevents unwanted movement of the antenna mat when placed in position on a floor or other substantially horizontal substrate. In some examples, the zone antenna layer is a printed coil antenna including of one or more layers of conductive ink. In other examples, the zone antenna layer is a flat copper wire spiral antenna. In some examples, the bottom substrate includes a recessed groove or track sized to receive the flat copper wire spiral antenna.

In some examples, in accordance with one or more techniques of the disclosure, the zone antenna system is configured to detect presence of one or more electronic tags in the detection zone established by the zone antenna system. In this way, the zone antenna system detects presence of the persons, equipment, or other objects associated with the tags in the detection zone. In some examples, the zone antenna system further stores entry event data corresponding to the detected presence of one or more electronic tags in the detection zone and/or wirelessly transmits the entry event data for receipt by one or more computing device(s).

In a hand hygiene compliance system example, the computing device analyzes the entry event data received from the zone antenna system in combination with dispenser data received from hand hygiene product dispensers to monitor hand hygiene compliance at a site.

In accordance with one or more techniques of the disclosure, the zone beacon unit and zone antenna mat may provide one or more technical advantages. For example, the antenna mat has a low profile (e.g., having a total thickness of between about 1 and 4 mm, or in a specific example, on the order of 0.1 inches (2.54 mm) thick) and is therefore thin enough that it will not pose a safety or a workflow issue when installed on a floor in a hospital room or other area within a facility. The top and bottom surfaces of the antenna mat are resistant to abrasion, scratching, flexing and creasing and are therefore robust enough to withstand walking traffic, having equipment rolled over it, and routine cleaning with abrasive or chemical cleaning products and equipment. The size of the detection zone may be optimized for a specific room/installation location and/or the particular application. In some examples, the antenna mat is sized to provide a detection zone suitable for standard, specialty, and/or rental patient beds. The antenna mat form factor provides a visual cue to hospital staff for proper positioning of the patient bed with respect to the antenna mat that helps ensure a patient bed is properly located within the detection zone established by the zone beacon unit and the antenna mat. The antenna mat form factor also provides a visual cue to individuals working with a patient (or in another monitored area) as to the location of the detection zone, thus providing an additional reminder to perform hand hygiene when entering or leaving the detection zone. In addition, in some examples, the zone antenna unit and zone antenna can be semi-permanently installed in a patient room and powered from an AC wall outlet, thus reducing the effort required to install the antenna systems throughout a facility, and eliminating the many costs associated with battery maintenance and disposal.

In addition, because neither the zone antenna nor the zone beacon unit of the disclosure are attached to the bed (or other object around which the detection zone is to be generated), the zone antenna system of the disclosure is advantageous in that it may be used to set up detection zones for stretchers or other mobile transport devices. Moreover, a semi-permanent antenna mounted on the floor, wall, or other substrate can be physically larger, provide more range (and thus a larger detection zone) and its range tuned to overcome the environmental noise of the specific room where it is installed.

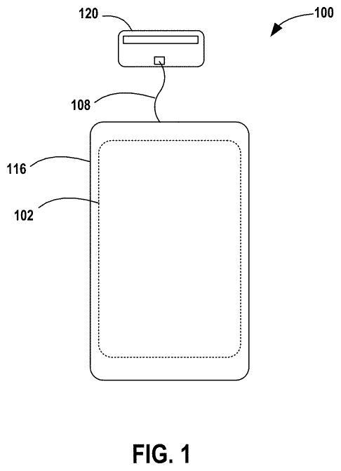

FIG. 1 is a block diagram of an example zone antenna system 100. Zone antenna system includes a zone antenna mat 116 and a zone beacon unit 120. In accordance with one or more techniques of the disclosure, zone antenna system 100 is configured to establish a detection zone, detect entry of an electronic tag into the detection zone, and store and/or wirelessly transmit entry event data corresponding to the detected entry events.

Antenna mat 116 is a substantially planar mat having a low or thin profile (e.g., on the order of 0.1 inches (2.54 millimeters) in height). However, other dimensions are also contemplated, and the disclosure is not limited in this respect. Antenna mat 116 is configured to be mounted or positioned substantially flat against a surface at a physical location where it is desired to set up a detection zone. In a hand hygiene compliance example, the zone antenna mat may be temporarily or semi-permanently mounted substantially flat on the floor under a patient bed to establish a detection zone around the patient bed, and thus around a patient. In another example, the zone antenna mat may be mounted substantially flat against a wall or other vertical or non-horizontal substrate.

Antenna mat 116 includes a substantially planar top substrate, a substantially planar bottom substrate and a substantially planar antenna layer 102 disposed between the top and bottom substrates. In some examples, zone antenna 102 is a printed coil antenna comprised of one or more layers of conductive ink. In other examples, zone antenna layer 102 is a flat copper wire spiral antenna. In some examples, the bottom substrate includes a recessed groove or track sized to receive the flat copper wire spiral antenna. However, these specific types of zone antennas are described herein for example purposes only and not by way of limitation. Other types of zone antennas configured to provide a suitable detection zone within a substantially flat form factor such as a mat or pad may also be used, and the disclosure is not limited in this respect.

The top and/or bottom substrate(s) may include, for example, any type of flexible and/or abrasion resistant polyimide or polyester material. The bottom substrate may also include an adhesive layer by which the antenna mat can be semi-permanently mounted to a floor, wall or other substrate. In other examples, the bottom substrate includes a synthetic rubber or other non-slip material that prevents unwanted movement of the antenna mat when placed in position on a floor or other substrate.

Zone beacon unit 120 and antenna mat 116 (and thus zone antenna 102) are electrically connected via connector 108. In some examples, a single zone beacon unit 120 may be connected to drive multiple zone antennas 102. Zone beacon unit 120 includes electronics and control circuitry configured to drive zone antenna 102 to generate a corresponding wireless detection zone. In one example, zone antenna 102 and zone beacon unit 120 are configured to generate a detection zone by transmitting a near-field radio frequency detection zone message. The detection zone message may be periodically transmitted at a predetermined time interval. In some examples, the predetermined time interval for periodic transmission of the detection zone message is once per second. However, other time intervals may also be used, and the disclosure is not limited in this respect. The range of the detection zone message may be tuned to overcome the environmental noise of the specific room where it is installed and/or to achieve a detection zone having desired dimensions for a particular application.

In accordance with one or more techniques of the disclosure, the zone antenna system is configured to detect presence of one or more electronic tags in the detection zone established by the zone antenna system. For example, zone beacon unit 120 is configured to communicate with one or more electronic tags present in the detection zone. An electronic tag present within the detection zone receives the detection zone message and transmits a zone presence reply message for receipt by zone beacon unit 120. In response to receiving a zone presence reply message, zone beacon unit 120 detects a corresponding entry event. Zone beacon unit 120 further stores entry event data corresponding to the detected entry event and/or wirelessly transmits the entry event data for receipt by one or more computing device(s). The computing device may analyze the entry event data received from one or more zone antenna systems at a site as part of an overall compliance monitoring system or other system in which presence of electronic tags in one or more detection zone(s) is monitored.

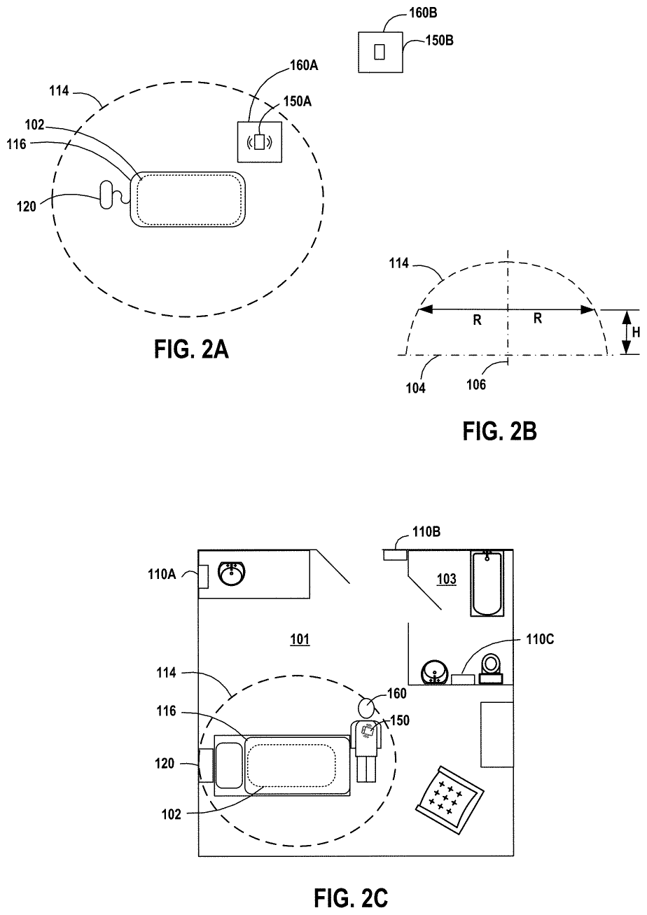

FIG. 2A is a diagram showing a top view of zone antenna mat 116, zone beacon unit 120, and a corresponding detection zone, indicated generally by dashed line 114, generated by zone antenna mat 116. Zone antenna mat 116 and zone beacon unit 120 are configured to detect presence of one or more electronic tags, such as electronic tag 150A, present within detection zone 114. A plurality of electronic tags 150, such as tags 150A and 150B, are uniquely associated with a plurality of different objects 160, in this case objects 160A and 160B, respectively. Objects 160 may be persons, equipment, or any other object whose presence in a detection zone 114 is to be detected. In some examples, the range of the detection zone may be adjusted anywhere between 12 and 400 inches from the center of the antenna mat 116 (i.e., the center of the antenna embedded within antenna mat). In a patient bed example, the detection zone may be set anywhere between about 12 inches and 48 inches from the center of antenna mat 116, or to extend about 1-2 feet around the edges of the patient bed in a hand hygiene compliance application.

FIG. 2B is a diagram showing a side view of example detection zone 114. In FIG. 2B, the center of zone antenna 102 is indicated by reference numeral 106 and a plane of antenna coil 102 is indicated by reference numeral 104. Because antenna mat 116 has such a thin profile, reference numeral 104 may also represent a floor, wall or other substrate on which antenna mat 116 is mounted.

A range (dimension R) of detection zone 114 is measured from the center 106 of zone antenna 102 at a height (dimension H) substantially horizontal to the plane 104 of antenna 102. Depending upon the geometry of antenna 102, the range, R, is not necessarily the same in all directions. Dimension H is the perpendicular measurement from the floor, wall, or other substrate to the level at which the range, R, is to be measured for a particular application. For example, in an application where presence of persons in a detection zone is to be monitored, electronic tags 150 may take the form of id badges worn at a height of about 4 feet as measured vertically from the ground (dimension H). In other examples, the range, R, may be measured at a height, H, of 0 inches (e.g., at floor or ground level, or at the level of a wall or other substrate to which the antenna mat is located). The range, R, may therefore be measured at any appropriate height, H, from the plane 104 of the antenna, and the disclosure is not limited in this respect.

Antenna 102 and zone beacon unit 120 are configured to generate a detection zone 114 by transmitting a near-field radio frequency detection zone message. The detection zone message may be periodically transmitted at a predetermined time interval. In some examples, the time interval for periodic transmission of the detection zone message is once per second. However, other time intervals may also be used, and the disclosure is not limited in this respect. The range, R, of the detection zone message may be tuned to overcome the environmental noise of the specific room where it is installed and/or to achieve a detection zone having desired dimensions for a particular application. The detection zone message may include, for example, a zone beacon unit id uniquely associated with the zone beacon unit 120 that generated the detection zone 114.

Referring again to FIG. 2A, each tag 150 is uniquely associated with a different object 160 for which presence in one or more detection zones 114 are to be detected. To that end, each tag 150 stores a unique tag address (e.g., a tag id or other tag identifier). In some examples, tag 150 also stores identification information concerning the object to which it is associated. For example, the tag may store a name of an associated person, a job role of an associated person (e.g., physician, nurse, physical therapist, etc.), an equipment id of an associated piece of equipment, an equipment type of an associated piece of equipment, or other information concerning the person, equipment or object with which the tag is associated. In other examples, a local and/or a remote computing device stores a unique association between each tag 150 and the associated object 160.

Each electronic tag 150 includes one or more wireless transceivers configured to receive, when present in a detection zone, a detection zone message transmitted by a zone antenna system. Upon receipt of a detection zone message, electronic tag 150 is further configured to transmit a zone presence reply message including the tag address to the zone beacon unit 120 that transmitted the detection zone message. For example, the zone presence reply message transmitted by a tag 150 may include the zone beacon unit address transmitted in the received detection zone message.

When electronic tag 150A (and thus, object 160A) enters detection zone 114, tag 150A receives the detection zone message transmitted by zone beacon unit 120/zone antenna 102. Electronic tag 150B (and thus, associated object 160B) is not present in the detection zone 114 and therefore does not receive the detection zone message or send a corresponding zone presence reply signal.

The detection zone message includes a zone beacon unit address uniquely associated with zone beacon unit 120. Upon receipt of the detection zone message, tag 150A generates a zone presence reply message including the zone beacon unit address and a tag address uniquely associated with electronic tag 150A. Upon receipt of the zone presence reply message, zone beacon unit 120 detects a corresponding “entry event.” In other words, upon receipt of the zone presence reply message from electronic tag 150A, zone beacon unit 120 determines that electronic tag 150A is present in the detection zone. Zone beacon unit 120 stores entry event data corresponding to the detected entry event and/or transmits the entry event data for receipt by one or more computing devices. The entry event data may include, for example, the date and time of the detected entry event, the zone beacon unit address associated with the detected entry event, and the tag address associated with the detected entry event.

FIG. 2C is a diagram of an example compliance monitoring environment including a including a zone antenna mat 116 having an embedded zone antenna 102 and a zone antenna unit 120, in accordance with one or more techniques of the disclosure. In this example, the compliance monitoring environment includes a patient room 101 at a hospital or other healthcare facility, and the zone antenna system forms part of a hand hygiene compliance system. However, the zone antenna system described herein may be used in other environments or applications in which compliance with one or more procedures is to be monitored, and the disclosure is not limited in this respect.

Patient room 101 includes a bathroom 103 and a patient bed 106. In accordance with one or more techniques of the disclosure, a zone antenna 116 and a zone antenna unit 120 are configured to generate a wireless detection zone 114. Zone antenna 116 is a substantially planar mat configured to be positioned on the floor under patient bed 106. Zone beacon unit 120 supplies power to zone antenna mat to generate wireless detection zone 114 around patient bed 106. Zone antenna unit 120 is located in the general vicinity of zone antenna mat 116. For example, zone antenna unit 120 may be mounted or placed on a wall, pole or table near the location in the patient room 101 where zone antenna mat 116 is installed.

Each individual whose hand hygiene practices are to be monitored is uniquely associated with an electronic tag 150. In the example of FIG. 1, healthcare worker 160 is uniquely associated with electronic tag 150. Electronic tag 150 is configured for wireless communication with zone beacon unit 120. Zone beacon unit 120 includes control electronics configured to power zone antenna 116 and generate detection zone 114, wirelessly communicate with one or more electronic tags 150 within detection zone 114, and store and/or wirelessly communicate data regarding presence of one or more electronic tags 150 in zone 114 to one or more local or remote computing device(s).

The purpose of detection zone 114 is to detect when a person, such as a healthcare worker 160 wearing an electronic tag 150, is close enough to a patient bed so that it is accurate to assume that the worker is interacting with a patient. Patient interactions are one factor that may be taken into account when determining when a healthcare worker is compliant with hand hygiene practices.

One or more hand hygiene product dispensers 110A-110C (also referred to herein generally as dispensers 110) are positioned in various locations around patient room 101. For example, dispenser 110A is located near a handwashing sink, dispenser 110B is located near a door to patient room 101, and dispenser 110C is located in a bathroom 103 of patient room 101. One or more of dispensers 110 are positioned in locations that make it convenient for healthcare workers to perform hand hygiene procedures, such as washing their hands with soap and water or using hand sanitizer. In some examples, each dispenser 110 includes a control unit configured to detect actuations of the dispenser (“dispense events”), wirelessly communicate with an electronic tag 150 within range of the dispenser upon detection of each dispense event, and wirelessly communicate data regarding detected dispense events to one or more local or remote computing device(s).

By establishing detection zones 114 around patient beds 106 or other areas in which a patient is likely to be located, detecting entry of electronic tags 150 (and thus the associated healthcare workers 160) into the detection zones 114, and analyzing those events in combination with hand hygiene dispense events attributed to each healthcare worker, hand hygiene practices at the healthcare facility may be monitored and compliance with proper hand hygiene practices may be determined.

Although specific applications of the zone antenna system 100 are described herein, these are for example purposes only, the disclosure is not limited in this respect. For example, the antenna system 100 may be configured for use in any application or system in which presence of persons or objects is to be monitored. The zone antenna systems 100 described herein may be used with any of the example systems or system components shown and described in U.S. Pat. No. 8,502,680 issued Aug. 6, 2013; U.S. Pat. No. 8,395,515 issued Mar. 12, 2013; U.S. Pat. No. 8,264,343 issued Sep. 11, 2012; U.S. Pat. No. 8,564,431 issued Oct. 22, 2013; U.S. Pat. No. 8,674,840 issued Mar. 18, 2014; U.S. Pat. No. 8,482,406 issued Jul. 9, 2013; U.S. Pat. No. 8,872,665 issued Oct. 28, 2014; U.S. Pat. No. 8,783,511 issued Jul. 22, 2014; U.S. Pat. No. 8,633,816 issued Jan. 21, 2014; U.S. Pat. No. 9,824,569 issued Nov. 21, 2017; U.S. patent application Ser. No. 15/912,999, filed Mar. 6, 2018; and U.S. patent application Ser. No. 16/723,234, filed December 2019; each of which is incorporated herein by reference in its entirety.

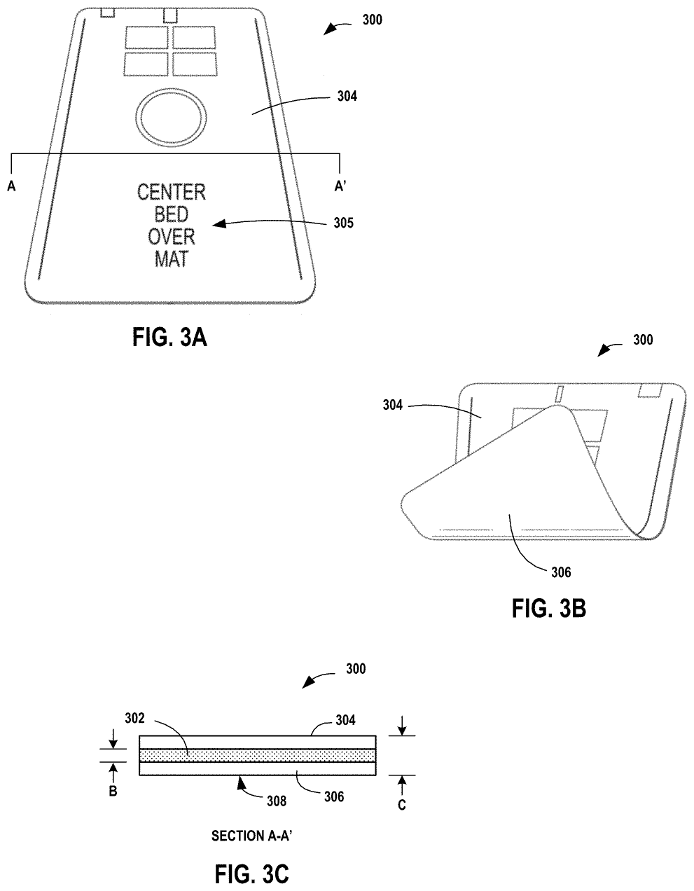

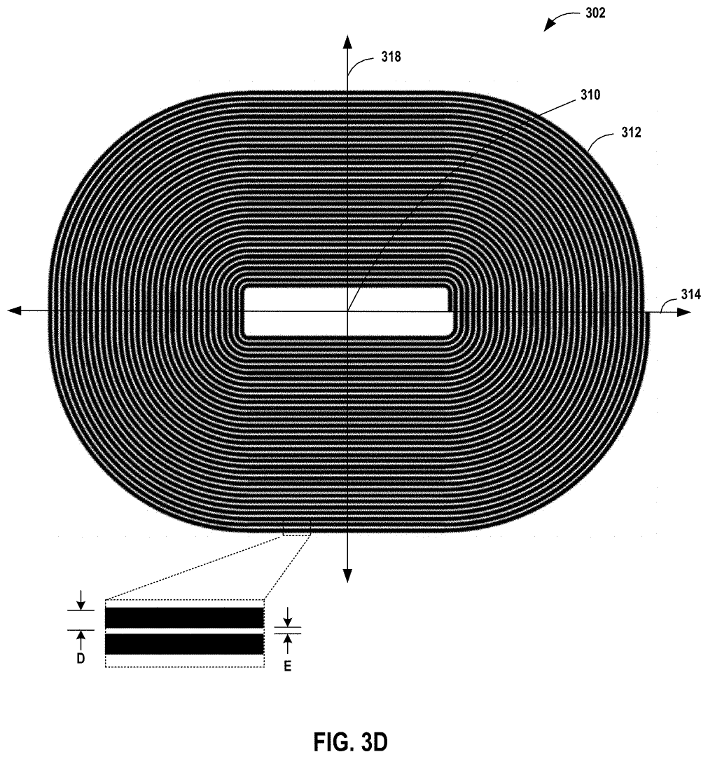

FIG. 3A is a top perspective view of an example zone antenna mat 300, in accordance with one or more techniques of the disclosure. FIG. 3B is another perspective view of example zone antenna mat 300 of FIG. 3A with one edge lifted up. FIG. 3C is a cross-sectional view of example zone antenna mat 300 of FIG. 3A taken along the line A-A′. FIG. 3D is a diagram of an example zone antenna layer 302, in accordance with one or more techniques of the disclosure.

As shown in FIGS. 3A-3C, example zone antenna mat 300 includes a top substrate 304, a bottom substrate 306 and an antenna layer 302 disposed between top substrate 304 and bottom substrate 306. In some examples, antenna layer 302 is sealed between substrates 304 and 306 to protect and prevent damage to antenna layer 302. The layers 302, 304, and 306 may be sealed using one or more types of adhesives or any type of laminating techniques. A zone beacon unit, such as zone beacon unit 120 of FIG. 1 or zone beacon unit 220 of FIG. 2, is connected to receive power from an AC wall outlet and/or one or more batteries, and is further connected to supply power to antenna layer 302 so as to establish a detection zone, such as detection zone 114.

In some examples, zone antenna mat 300 has overall dimensions of approximately 24 inches wide by 36 inches long and approximately 0.1 inch (2.54 millimeters) thick (dimension C in FIG. 3C). Antenna layer 302 is between about 0.001 inches and 0.009 inches thick. However, zone antenna mat may include dimensions selected to achieve the desired antenna characteristics, and the disclosure is not limited in this respect. Top substrate 304 and/or bottom substrate 306 of zone antenna mat 300 may include, for example, any type of flexible and/or abrasion resistant polyimide or polyester film. Bottom substrate 306 of zone antenna mat 300 may alternatively or in addition include an adhesive layer or EPDM (Ethylene Propylene Diene Monomer) synthetic elastomer or other non-slip layer. In some examples, the top and/or bottom substrate of the zone antenna mat are resistant to abrasion, scratching, flexing and creasing so as to be resistant to various sources of wear typically encountered in a hospital environment or other environment such as foot traffic, abrasive or chemical cleaning products, and rolling or dragging of hospital beds or other equipment on or over zone antenna mat 300, and the like.

Zone antenna mat 300 may be configured for either temporary or semi-permanent installation on a floor, wall, or other substrate. In a semi-permanent configuration, bottom substrate 306 of zone antenna mat 300 may include an adhesive layer and a release liner 308. Release liner 308 is removed before adhering zone antenna mat 300 to the substrate. In a temporary configuration, bottom substrate 306 of zone antenna mat 300 may include an EPDM synthetic elastomer (e.g., synthetic rubber) or other non-slip material.

Top substrate 304 may include graphics designed to aid staff members in properly orienting zone antenna mat 300 such that the detection zone established by zone antenna mat 300 is properly oriented around the physical area to be monitored. For example, zone antenna mat 300 includes the graphics “Center Bed Over Mat” and/or one or more other graphics 305 to provide hospital staff with a visual guide as to where to place a hospital bed with respect to zone antenna mat 300.

In one example installation, one or more zone antenna mats 300 may be positioned on the floor of a hospital room, in an ICU, or in many such rooms or areas in a healthcare facility and left in place to provide a visual guide for proper placement of a patient bed (or other medical transport or patient support device such as a gurney, stretcher, wheelchair, lift, bench, exam or treatment table, procedure or reclining chair, etc.) with respect to the zone antenna mat 300. A zone beacon unit for each antenna mat 300 (or a zone beacon unit that drives multiple zone antenna mats 300) is plugged into a standard AC wall outlet, and the zone antenna mat(s) 300 connected to the zone beacon unit. Installation of the zone antenna system is simplified in that both the zone beacon unit(s) and the antenna mat(s) are installed in appropriate locations in the room rather than mounted to a patient bed or other object around which a detection zone is to be established. As one example, objects such as patient beds can be removed from a first location or room with respect to a first antenna mat/detection zone to a second location or room with respect to a second antenna mat/detection zone without requiring hospital staff to perform any adjustments (e.g., power on or off, adjust the range, etc.) to the zone beacon unit or the antenna mat. For example, a patient may be moved in their patient bed from a first location, such as their patient room, with respect to a first antenna mat/detection zone in the patient room to a second location in the healthcare facility with respect to a second antenna mat/detection zone at the second location to undergo tests or other procedures, and then returned to the first location over the first antenna mat/detection zone. In this way, detection zones can be set up in almost any desired location and remain in place (at least temporarily or on a semi-permanent basis) and the patient(s)/patient bed(s)/other object(s) moved from one detection zone to another detection zone without the need for adjustments to the zone beacon units or the antenna mats by staff members. In addition, unintentional zone entry events are not detected in hallways or other common areas, because the beacon unit/zone antenna/detection zone does not move with the patient bed, but are instead associated with an installed location.

FIG. 3D is a diagram of an example zone antenna layer 302, in accordance with one or more techniques of the disclosure. Example antenna layer 302 includes a substantially flat (planar) spiral-shaped coil antenna 312 comprised of two or more turns. In some examples, antenna coil 312 includes between 15 and 40 turns. In the example shown in FIG. 3D, antenna coil 312 includes a 34-turn planar spiral design with 0.20″ tracks (dimension D) and 0.10″ gaps (dimension E). A center of antenna coil 312 is indicated by reference numeral 310. A longitudinal axis of example antenna coil 312 is indicated by reference numeral 314 and a transverse axis of antenna coil 312 is indicated by reference numeral 318. In general, longitudinal axis 314 corresponds to the longest length dimension of the antenna coil 312 and/or the antenna mat and transverse axis 318 corresponds to the shortest length dimension of antenna coil 312. In a hand hygiene application, for example, the center 310 of antenna coil 312 may be generally centered under a patient bed with the longest length dimension of antenna coil 312 oriented approximately parallel to the longest length dimension (generally the side) of a patient bed and with the shortest length dimension of antenna coil 312 oriented approximately parallel to the shortest length dimension (generally the head or foot sides) of a patient bed. Although in the example of FIG. 3D the longitudinal dimension of antenna coil 312 is generally longer as compared to the transverse dimension, in some other examples the relative lengths of the longitudinal and transverse dimensions are reversed, and in other examples the longitudinal and transverse dimensions are substantially equivalent, and the disclosure is not limited in this respect.

In general, antenna layer 302 may include a spiral-shaped coil antenna having two or more turns and having a track width of between 0.05 and 0.5 inches and having a gap width of between 0.05 and 0.5 inches. In some examples, the antenna includes between 15 and 40 turns. The overall dimensions of the antenna may be between 5 inches and 48 inches in the longitudinal and/or the transverse dimensions. However, the overall dimensions, track/gap width, number of turns, etc. of the antenna may be varied to achieve a detection zone having desired characteristics, and that the disclosure is not limited in this respect.

In some examples, antenna layer 302 comprises one or more layers of conductive ink. Antenna layer 302 may also include one or more dielectric layers and/or one or more adhesive layers. In some examples, zone antenna mat 300 is fabricated by printing antenna coil 312 onto a substrate using one or more layers of conductive ink. In some examples, antenna coil 312 is printed on a bottom side of top substrate 304 using one or more layers of conductive ink. Bottom substrate 306 is then adhered to the bottom side of top substrate 304 to form antenna mat 300. However, zone antenna mat 300 may be fabricated using other methods, and the disclosure is not limited in this respect.

Although a specific example antenna coil 312 is shown and described with respect to FIGS. 3A-3D for purposes of illustration, it shall be understood that the disclosure is not limited in this respect. For example, the overall dimensions, shape, layout, number of turns, conductive material, number of layers of conductive ink, and/or method of manufacture may be varied, and the disclosure is not limited in this respect. The conductive ink may include any type of conductive ink including, but not limited to, a conductive silver ink, a conductive silver composition ink, a conductive silver and carbon ink, a conductive carbon ink, a silver chloride ink, a dielectric ink, etc. The conductive inks may be applied by any suitable method including, but not limited to, screen printing, ink-jet printing, pad printing, flexography, rotogravure or other conductive ink or RF antenna printing techniques. The antenna layer may include any appropriate number of layers of conductive ink to achieve the desired antenna characteristics. For example, the antenna layer may include between one and ten layers of conductive ink, or more than ten layers of conductive ink. In other examples, instead of or in addition to conductive ink, the conductive material may further include etched copper or other etched conductive metals, copper wire, or any other type of conductive material.

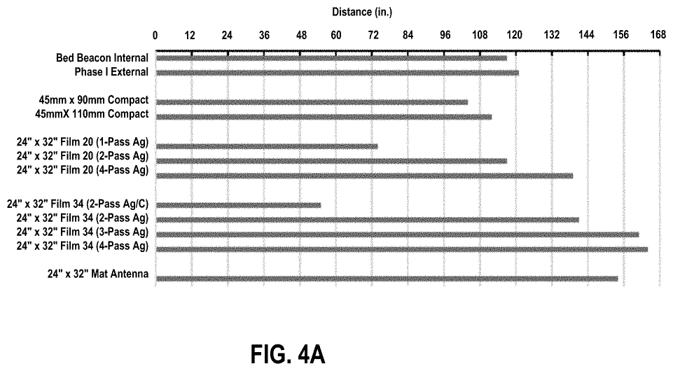

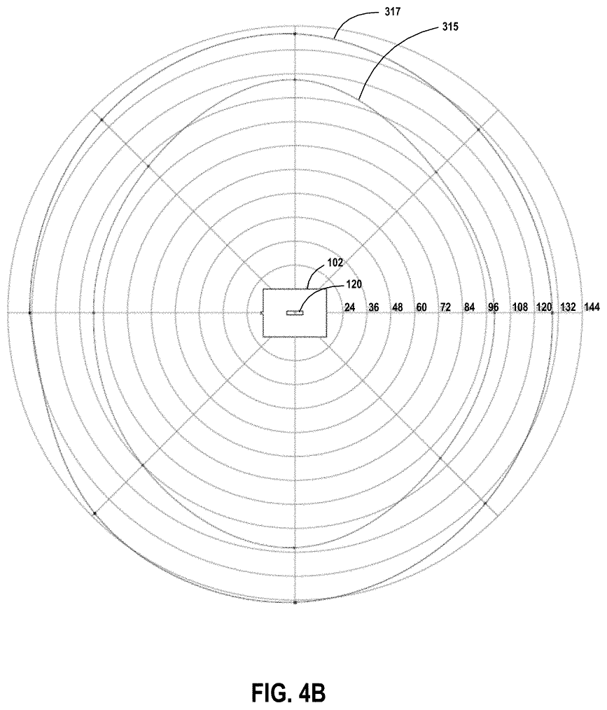

FIG. 4A is a graph showing range measurements for several example zone antennas, in accordance with one or more techniques of the disclosure. Several example antenna coils were printed on a 24″×36″ polyester film surface for purposes of testing as shown and described with respect to FIG. 4A and Table 1. A zone beacon module internal antenna (first row of Table 1) and several example antennas fabricated using copper wire (antennas 2, 3, 4, and 12) are shown for comparison purposes. The inductance and capacitance of the tuning circuits for each example antenna were selected such that the antennas resonated at 125 kilohertz (kHz). Antennas 9, 10, and 11 correspond to the 34-turn antenna design shown in FIG. 3D.

The results are summarized in Table 1 below. The results show the Range (last column) in the longest range dimension. The test results were obtained under the following conditions:
1. Tag oriented vertically at 48″ elevation.
2. Zone beacon unit oriented vertically at 10″ elevation.
3. Mat Antenna oriented horizontally at 0″ elevation (on the floor).
4. Zone beacon unit near-field range set to 10 (maximum).

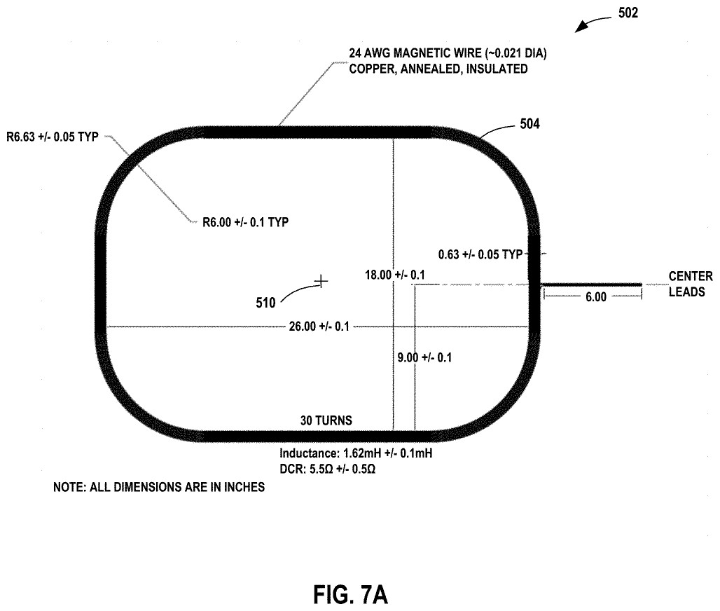

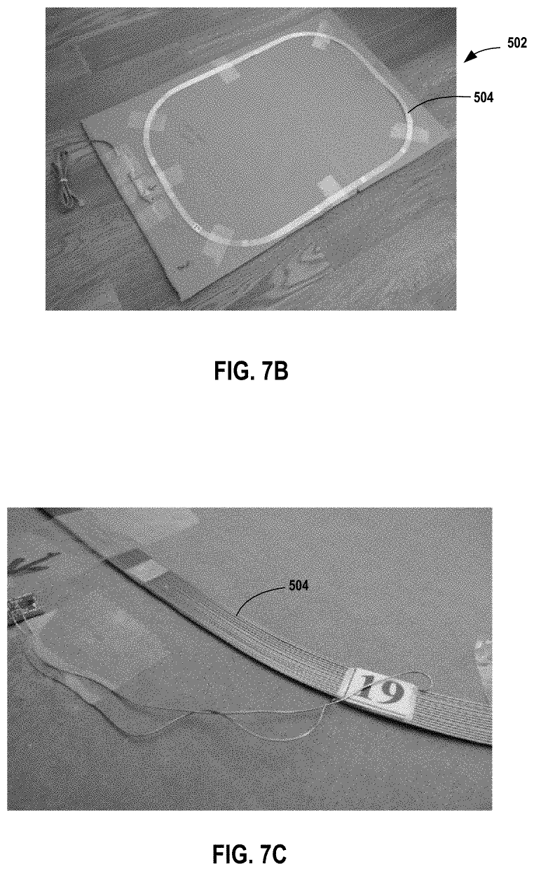

TABLE 1

| | | | Track/ | Range |
|---|---|---|---|---|
| | Antenna Type | Description | Gap (in.) | (in.) |
| 1 | Beacon Unit | 60 Turns, | | 117 |
| | Internal | 30 AWG | | |
| 2 | External | 60 Turns, | | 121 |
| | | 30 AWG | | |
| 3 | 45 mm × 90 | 160 Turns, | | 104 |
| | mm Compact | 26 AWG | | |
| 4 | 45 mm × 110 | 160 Turns, | | 112 |
| | mm Compact | 26 AWG | | |
| 5 | 24″ × 32″ Film | 20 Turns, | 0.25″/ | 74 |
| | 20 (1-Pass Ag) | Silver Ink | 0.25″ | |
| 6 | 24″ × 32″ Film | 20 Turns, | 0.25″/ | 117 |
| | 20 (2-Pass Ag) | Silver Ink | 0.25″ | |
| 7 | 24″ × 32″ Film | 20 Turns, | 0.25″/ | 139 |
| | 20 (4-Pass Ag) | Silver Ink | 0.25″ | |
| 8 | 24” × 32″ Film | 34 Turns, | 0.20″/ | 55 |
| | 34 (2-Pass | Silver and | | |
| | Ag/C) | Carbon Ink | 0.10″ | |
| 9 | 24″ × 32″ Film | 34 Turns, | 0.20″/ | 141 |
| | 34 (2-Pass Ag) | Silver Ink | 0.10″ | |
| 10 | 24″ × 32″ Film | 34 Turns, | 0.20″/ | 161 |
| | 34 (3-Pass Ag) | Silver Ink | 0.10″ | |
| 11 | 24″ × 32″ Film | 34 Turns, | 0.20″/ | 164 |
| | 34 (4-Pass Ag) | Silver Ink | 0.10″ | |
| 12 | 24″ × 32″ Mat | 30 Turns, | | 154 |
| | Antenna | 30 AWG | | |
| 13 | 18″ × 26″ Mat | 30 Turns, | | 240* |
| | Antenna | 24 AWG | | |
| | (FIG. 7A) | | | |

*range set at 8 out of 10. The maximum range at range setting 10 would be higher, such as up to 400″.

FIG. 4B shows a range plot 317 for an example 24″×32″ antenna coil comprised of a 20-turn planar spiral design with 0.20″ tracks and 0.10″ gaps, and printed with 4 layers of conductive silver ink (row 7 of Table 1). A range plot 315 for a beacon unit internal antenna is also shown for comparison purposes.

In accordance with one or more techniques of the disclosure, the zone antenna mats 116/300/520 may provide one or more technical advantages. For example, zone antenna mat 116/300/520 has a thin profile (e.g., on the order of 0.1 inches (2.54 mm)) and is therefore thin enough that it will not pose a safety or a workflow issue when installed in a hospital room or other area to be monitored. The top and bottom surfaces of the zone antenna mat are resistant to abrasion, scratching, flexing and creasing and are therefore robust enough to withstand walking traffic, having equipment rolled over it, and routine cleaning with abrasive or chemical cleaning products and equipment. The size of the detection zone may be optimized for a specific room/installation location. The zone antenna mat is sized to provide a detection zone suitable for standard, specialty and/or rental patient beds. The zone antenna mat form factor provides a visual cue to staff members that helps ensure a patient bed or other object is properly located within the detection zone. The zone antenna mat form factor also provides a visual cue to individuals working with a patient (or in another monitored area) as to the location of the detection zone, thus providing an additional reminder to perform hand hygiene when entering or leaving the detection zone. In addition, in some examples, the zone antenna unit and zone antenna mat can be semi-permanently installed in a patient room and powered from an AC wall outlet, thus reducing the effort required to install the antenna systems throughout a facility, and eliminating the many costs associated with battery maintenance and disposal.

In addition, because the zone antenna mat and zone antenna unit of the disclosure are not attached to a bed or other object, the zone antenna system of the disclosure is advantageous in that it may be used to set up detection zones for stretchers and other mobile transport devices and/or other movable objects without requiring attachment of the zone beacon unit or the zone antenna themselves to the object. Moreover, a semi-permanent zone antenna mat mounted on a floor, wall, or other substrate can be physically larger, provide more range (and thus a larger detection zone) and its range tuned to overcome the environmental noise of the specific room where it is installed.

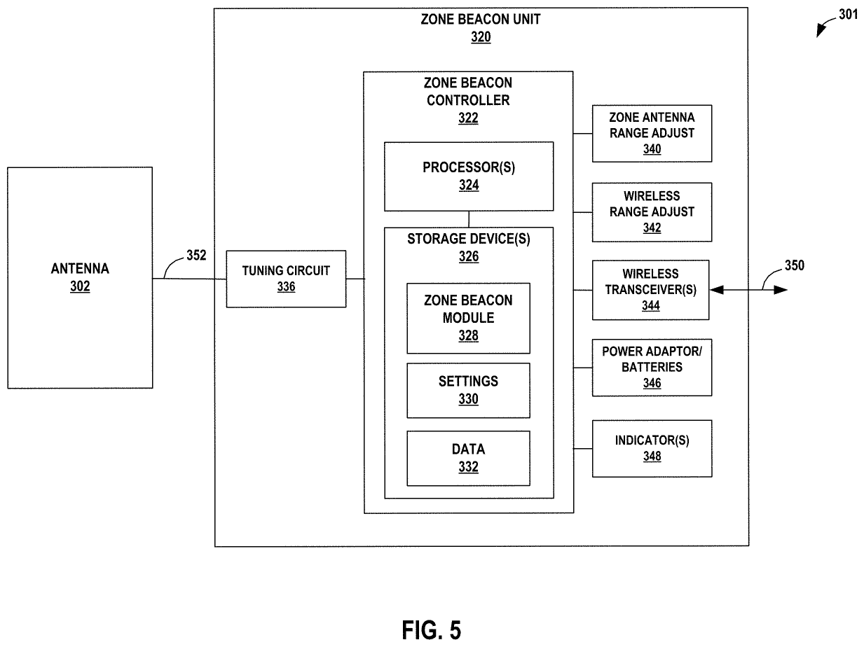

FIG. 5 is a block diagram of an example zone antenna system 301 including an example zone antenna 302 and an example zone beacon unit 320, in accordance with one or more techniques of the disclosure. In this example, zone beacon unit 320 includes a controller 322 that includes one or more processors 324 and one or more storage device(s) 326. Processors 324 may include, for example, any one or more of a microprocessor, a controller, a digital signal processor (DSP), an application specific integrated circuit (ASIC), a field-programmable gate array (FPGA), or equivalent discrete or integrated logic circuitry, including other hardware processors or processing circuitry.

Example zone beacon unit 320 further includes a tuning circuit 336, one or more wireless transceiver(s) 344, zone antenna range adjustment 340, wireless transceiver range adjustment 342, power adaptor and/or batteries 346 and one or more audio and/or visual indicators 348. Tuning circuit 336 includes one or more inductors and/or capacitors selected such that antenna 302 resonates at the desired transmit frequency. In some examples, tuning circuit 336 and antenna 302 are configured such that antenna 302 resonates at a radio frequency between 30 kHz and 300 kHz, and, in some specific examples, at a radio frequency of 125 kHz.

Zone antenna range adjustment 340 provides for adjustment of the driving voltage to zone antenna 302, resulting in adjustment of the range of the resulting detection zone provided by zone antenna 302. In some examples, range adjustment 340 may provide for between two and twenty different range settings. In one particular example, range adjustment 340 may provide ten different range settings, e.g., settings 1-10, where 1 is the lowest (smallest) range setting and 10 is the highest (largest) range setting. However, these are given for example purposes only, and the disclosure is not limited in this respect.

In some examples, wireless transceiver(s) 344 of zone beacon unit 320 are configured for one or more types of wireless communication. For example, wireless transceivers 344 of zone beacon unit 320 are configured to establish a detection zone by transmission of a near-field radio frequency detection zone message under control of zone beacon controller 322. As another example, wireless transceivers 344 of zone beacon unit 320 are configured to wirelessly communicate (e.g., by receiving a zone presence reply message and/or transmitting a zone presence acknowledge message) with one or more electronic tags present in a detection zone established by zone antenna 302. As another example, wireless transceivers 344 of zone beacon unit 320 are further configured to wirelessly transmit entry event data detected with respect to the associated detection zone to one or more local and/or remote computing device(s) via one or more networks. As another example, zone beacon unit 320 may receive remote software updates, remote configuration settings (e.g., wireless range settings and/or zone configuration settings) from one or more local or remote computing devices. Zone beacon unit 320 may further communicate with one or more other computing devices, such as those associated with one or more dispensers, with other zone beacon units or with other such devices in a healthcare setting that may be useful for monitoring of hand hygiene compliance, or for any application in which the zone antenna system is used.

One or more storage devices 326 are configured to store information within zone beacon unit controller. Storage devices 326, in some examples, can be described as a computer-readable storage medium. Storage devices may include temporary or volatile memory. Examples of volatile memories include random access memories (RAM), dynamic random access memories (DRAM), static random access memories (SRAM), and other forms of volatile memories known in the art. Storage devices may further include non-volatile memory such magnetic flash memories, or forms of electrically programmable memories (EPROM) or electrically erasable and programmable memories (EEPROM).

In some examples, storage devices 326 are used to store program instructions, such as zone beacon module 328, for execution by processor(s) 324. Storage devices 326 may further be used by processor(s) 324 to temporarily store information during program execution. In some examples, storage devices 326 include a buffer that stores entry event data associated with one or more entry events that occurred with respect to the detection zone established by zone antenna 302.

Zone beacon module 328 of zone beacon unit 320 includes instructions that, when executed by processors 324, cause processors to control power to an associated zone antenna to establish a detection zone. For example, to establish a detection zone (e.g., detection zone 114 of FIG. 1), zone beacon unit 320 may control power to zone antenna 302 to periodically transmit a near-field detection zone message. In some examples, zone beacon unit 320 transmits the detection zone message at a first frequency, wherein the first frequency includes a radio frequency in a range from 30 kHz to 300 kHz. In some more specific examples, the first frequency includes a radio frequency of about 125 kHz. Zone beacon unit 320 periodically broadcasts the detection zone message at a predetermined time interval, such as once per second, or at any other appropriate time interval. The detection zone message includes a zone beacon address (or other zone beacon identifier) corresponding to the zone beacon unit 320 that transmitted the periodic detection zone message.

Zone beacon module 328 further includes instructions that, when executed by processors 324, enable controller 322 to wirelessly communicate with one or more electronic tags present in the detection zone, detect entry of an electronic tag into the detection zone (e.g., detect entry events), and store and/or wirelessly transmit entry event data via wireless transceiver 344 to one or more local or remote computing devices.

In one example use scenario, an electronic tag, such as a tag 150 as shown in FIGS. 2A and/or 2C, within range of the near-field detection zone broadcast (that is, within the detection zone) receives the detection zone message. In some example implementations, if the electronic tag is in a sleep or lower power state, receipt of the detection zone message “wakes up” the electronic tag controller. In response to receipt of the detection zone message, the electronic tag transmits a zone presence reply message. The zone presence reply message includes, for example, a tag address (or other tag identifier) and the zone beacon unit address contained in the detection zone message. In some examples, the electronic tag transmits the zone presence reply message at a second frequency, wherein the second frequency includes a frequency within the 915 MHz ISM (industrial, scientific and medical) radio band (i.e., a frequency range from about 902 MHz to about 928 MHz and having a center frequency of about 915 MHz).

In some examples, the zone beacon reply message is transmitted by an electronic tag at a second frequency that is different from the first frequency of the detection zone message broadcast. This may be advantageous in some implementations for several reasons. The communication range via the second frequency (e.g., within the 915 kHz ISM band) may be longer than that of the communication of detection zone message via the first frequency (e.g., near-field 125 kHz). Thus, if a person (or other object) having an associated electronic tag only briefly enters a detection zone, the zone presence reply message will be received by the zone beacon unit even if the zone presence reply message is sent after the tag leaves the zone. As another example, transmission of the zone presence reply message via the second frequency may require less power than transmission via the first frequency. This may help to reduce power requirements of the electronic tags, enabling use of smaller battery sizes to power the tags and a corresponding reduction in tag size and weight, and/or extending battery life. In addition, a UHF (915 kHz ISM band) radio transmitter requires less circuit board real-estate than a near-field transmitter, further enabling a reduction in the overall size and weight of the electronic tag. UHF is more noise immune, which provides better signal integrity for the larger zone presence reply message. Further, the zone beacon includes a UHF radio for purposes of communicating with a network and/or one or more local or remote computing devices, so there is something to talk to. Further, by using the UHF receiver in the zone beacon module, the zone beacon unit does not need to include a near-field receiver, thus simplifying the design of the zone beacon unit.

Zone beacon unit 320 is configured to receive the zone presence reply message via wireless transceiver(s) 344. In some examples, zone beacon unit 320 transmits a acknowledge message (for example, via the second frequency) to the electronic tag by which electronic tag can confirm that its zone presence reply message was received.

In some examples, an electronic tag may be programmed to transmit only a single zone beacon reply message upon first receiving the detection zone message upon entry into a detection zone. In such examples, zone beacon module 328 may detect an entry event upon receipt of a zone beacon reply message. Transmission of a single zone beacon reply message may help to reduce power consumption by an electronic tag as compared to examples in which the tag transmits a zone beacon reply message upon receipt of each periodically transmitted detection zone message. However, in implementations where detection of the length of time a tag remains in a detection zone is desired, electronic tag(s) 150 may transmit a zone presence reply message in response to each received detection zone message.

Zone beacon module 328 further includes instructions that, when executed by processors 324, cause zone beacon unit 320 to, in response to receipt of a zone presence reply message from an electronic tag, detect an entry event. For example, in implementations where electronic tag(s) 150 are configured to transmit a single zone presence reply signal in response to receipt of one or more detection zone messages corresponding to a particular zone beacon unit 320, zone beacon module 328 may cause processor(s) 324 to detect an entry event in response to receipt of a detection zone message.

Alternatively, in implementations in which electronic tag(s) 150 are configured to transmit a zone presence reply message in response to receipt of each detection zone message received by the tag, zone beacon module 328 may include a timer by which zone beacon unit 320 determines whether one or more previous zone presence reply messages have been received from the tag address included in the zone presence reply within a predetermined period of time. If no zone presence reply messages associated with the tag address have been received during the predetermined period of time, this means that the electronic tag associated with that tag address has entered the detection zone. Zone beacon module 328 may then cause processor(s) 324 to detect an entry event associated with the tag address included in the zone presence reply message.

Alternatively, if zone beacon module 328 determines that one or more previous zone presence reply messages have been received from the tag address included in the zone presence reply within the predetermined period of time, this means that the electronic tag associated with that tag address was previously present in the detection zone during the predetermined period of time. Zone beacon module 328 would not detect an entry event in that circumstance. Rather, in some examples, zone beacon module 328 may detect a continued “presence” of the electronic tag within the zone. In some other examples, zone beacon module 328 may store the time and date of any subsequent zone presence reply messages without detecting an event, or may ignore receipt of any subsequent zone presence reply messages without storing any associated data.

Upon detection of an entry event, zone beacon module 328 causes processor(s) 234 to generate entry event data corresponding to each detected entry event. In some examples, zone beacon module 328 includes instructions that cause processors 324 to store entry event data corresponding to one or more detected entry events in data storage 332. In addition or alternatively, zone beacon module 328 includes instructions that cause processors 324 to transmit entry event data corresponding to one or more detected entry events for receipt by one or more local and/or remote computing devices.

Zone beacon unit 320 may further transmit status information to one or more local and/or remote computing devices. The status information may include, for example, a current battery status of the zone beacon unit, a total number of entry events detected by the zone beacon unit during a predetermined time interval, and/or any other zone beacon unit status information. The status information may further include electronic tag status information received from one or more electronic tags present in the detection zone. For example, the zone presence reply message received from an electronic tag may include status information associated with the electronic tag, such as tag battery status, compliance status, or other tag status information.

Zone beacon unit 320 may wirelessly transmit (as indicated by reference numeral 350) via wireless transceivers 344 entry event data to one or more local and/or remote computing devices. The communication 350 of the entry event data may be over one or more networks. In some examples, zone beacon unit 320 wirelessly transmits entry event data in near real-time each time an entry event is detected. In other examples, zone beacon unit 320 wirelessly transmits entry event data corresponding to multiple entry events on a periodic basis or on demand. The local and/or remote computing device(s) may analyze the entry event data to identify entry of persons or objects in the one or more detection zones at a site. In some examples, the local and/or remote computing device(s) may analyze the entry event data in combination with other data to monitor compliance with one or more predefined procedure(s) at the site. For example, the local and/or remote computing device(s) may analyze the entry event data in combination with dispense event data received from one or more product dispensers to monitor hand hygiene compliance of workers at one or more sites.

Zone beacon unit 320 includes a power adaptor and/or one or more batteries 346. In some examples, zone beacon unit 320 is powered through a line voltage, such as a 120V AC power source or other standardized line voltage. In addition or alternatively, zone beacon unit 320 may include one or more batteries which can be used to power zone beacon unit 320 in the event that line power is not available or zone beacon unit 320 is unplugged from the wall outlet. Antenna 302 is connected to receive power from zone beacon unit 320 via a connector 352. By receiving power from zone beacon unit, which is in turn powered from a line voltage, the uniformity and reliability of the detection zone established by the zone beacon unit 320 and zone antenna 302 may be increased.

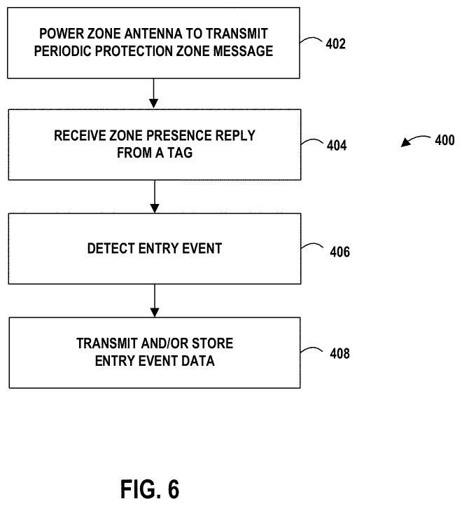

FIG. 6 is a flowchart illustrating an example process (400) by which a zone beacon unit, such as any one of zone beacon units 120 and/or 320, may detect entry of an electronic tag into a detection zone and store and/or wirelessly transmit entry event data associated with the detected entry event. Zone beacon unit 120/320 establishes the detection zone by powering an associated zone antenna (such as zone antenna 102/302/502) to transmit a periodic detection zone message (402).

In some examples, zone beacon unit 120/320 transmits the detection zone message at a first frequency, wherein the first frequency includes a radio frequency in a range from 30 kHz to 300 kHz. In some more specific examples, the first frequency includes a radio frequency of about 125 kHz. Zone beacon unit 120/320 periodically broadcasts the detection zone message at a predetermined time interval, such as once per second, or at any other appropriate time interval. The detection zone message includes a zone beacon address (or other zone beacon identifier) corresponding to the zone beacon unit 120/320 that transmitted the periodic detection zone message.

An electronic tag, such as a tag 150 as shown in FIGS. 2A and/or 2C, within range of the near-field detection zone broadcast (that is, within the detection zone) receives the detection zone message. In response to receipt of the detection zone message, the electronic tag transmits a zone presence reply message. The zone presence reply message includes, for example, a tag address (or other tag identifier) and the zone beacon unit address contained in the detection zone message (in other words, the address of the intended recipient). In some examples, the electronic tag transmits the zone presence reply message at a second frequency, wherein the second frequency includes a frequency within the 915 MHz ISM (industrial, scientific and medical) radio band (i.e., a frequency range from about 902 MHz to about 928 MHz and having a center frequency of about 915 MHz).

Zone beacon unit 120/320 receives a zone presence reply message from an electronic tag within the detection zone (404). Zone beacon unit 120/320 checks the intended recipient zone beacon unit address to determines whether it is the intended recipient. In some examples, if the zone beacon unit determines it is the intended recipient of the zone presence reply message, the zone beacon unit sends an acknowledge message (for example, via the second frequency) to the electronic tag to confirm that the zone presence reply message was received.

In response to receipt of the zone presence reply message, zone beacon unit detects an entry event (406). The zone beacon unit 120/320 stores and/or wirelessly transmits entry event data corresponding to the detected entry event for receipt by one or more local and/or remote computing devices (414).

FIG. 7A is a diagram of another example zone antenna layer 502, in accordance with one or more techniques of the disclosure. FIGS. 7B and 7C show an overall perspective view and a close-up perspective view of antenna layer 502, respectively. Example antenna layer 502 includes a substantially flat (planar) spiral-shaped antenna coil 504 comprised of two or more turns. In some examples, antenna coil 504 comprises two or more turns of copper wire. Antenna layer 302 may also include one or more dielectric layers and/or one or more adhesive layers. In some examples, antenna coil 504 includes between 15 and 40 turns. In the example shown in FIG. 7, antenna coil 504 includes a 30-turn substantially planar spiral loop (e.g., racetrack) of copper wire. Each loop of copper wire (i.e., track) in the planar spiral is positioned substantially adjacent to the previous and/or successive loop(s); that is, the track width (distance or gap between tracks) is substantially zero. A center of antenna coil 504 is indicated by reference numeral 510. A longitudinal axis of example antenna coil 504 corresponds to the longest length dimension of the antenna coil 504 and/or the antenna mat and a transverse axis corresponds to the shortest length dimension of antenna coil 504. In a hand hygiene application, for example, the center 510 of antenna coil 504 may be generally centered under a patient bed with the longest length dimension of antenna coil 504 oriented approximately parallel to the longest length dimension (generally the side) of a patient bed and with the shortest length dimension of antenna coil 504 oriented approximately parallel to the shortest length dimension (generally the head or foot sides) of a patient bed. Although in the example of FIG. 7A the longitudinal dimension of antenna coil 504 is generally longer as compared to the transverse dimension, in some other examples the relative lengths of the longitudinal and transverse dimensions are reversed, and in other examples the longitudinal and transverse dimensions are substantially equivalent, and the disclosure is not limited in this respect.

The overall dimensions of the antenna coil 504 may be between 5 inches and 48 inches in the longitudinal and/or the transverse dimensions. However, the overall dimensions, track/gap width, number of turns, etc. of the antenna may be varied to achieve a detection zone having desired characteristics, and that the disclosure is not limited in this respect. In the example of FIG. 7, the inside dimension in the longitudinal dimension is approximately 26.00+/−0.1 inches, the inside dimension in the transverse direction is approximately 18.00+/−0.1 inches. The outside radius of each corner is approximately 6.63+/−0.05 and the inside radius is approximately 6.00+/−0.1. The total width of an example 30 turn copper wire coil 504 comprised of 24 AWG magnetic wire having a diameter of approximately 0.021 inches is approximately 0.63+/−0.05 inches. The detection zone of an example antenna mat including an 18″×26″ antenna coil such as that shown in FIG. 7A is shown in Table 1 above as approximately 240 inches at a range setting of “8”. In general, a copper loop antenna such as that shown in FIGS. 7A-7C will have a lower DC resistance (DCR) than a printed silver ink antenna such as those described above. Depending on the amount of noise or other interference present in the environment, a copper loop antenna such as shown in FIGS. 7A-7C may provide for different or more appropriate detection zone range in certain circumstances; however, the disclosure is not limited in this respect. In general, any substantially planar antenna configured to provide detection zone range(s) appropriate for the desired application and that can be incorporated into a mat-type form factor is considered to be within the scope of the disclosure.

As shown in Table 1, for example, the range for an example 18″×26″ mat antenna comprised of 30 turns of 24 AWG copper wire was measured at 240 inches at range setting 8. This shows that the maximum range achievable by the example planar copper loop antenna is generally longer than that for the example printed conductive ink antennas even in a low noise environment. This means that the example planar copper loop antenna in accordance with one or more techniques of the disclosure can provide sufficient detection zone range even in the presence of noise or other types of interference.

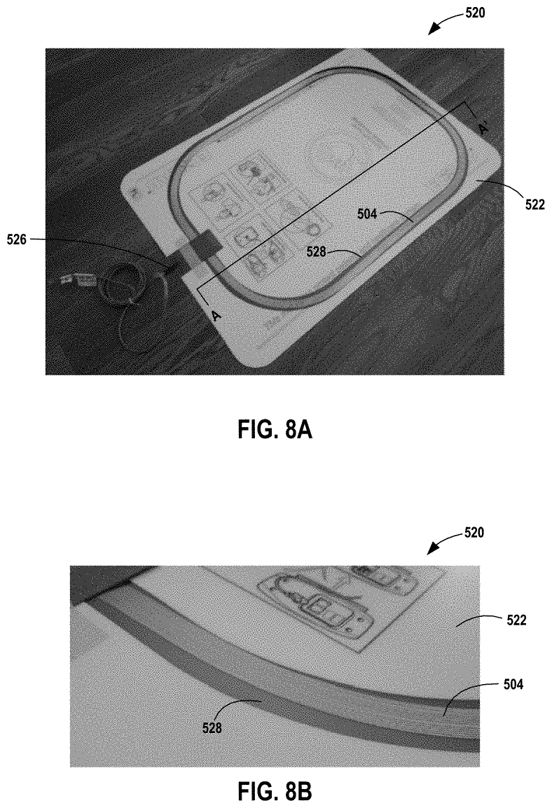

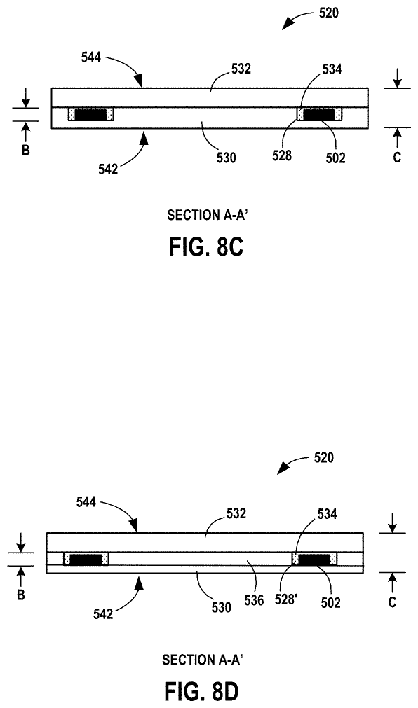

FIG. 8A is a top perspective view of an example zone antenna mat 520 incorporating a copper loop antenna such as that shown in FIG. 7A, in accordance with one or more techniques of the disclosure. FIG. 8B is a close-up perspective view of example zone antenna mat 520 of FIG. 8A. FIG. 8C is an alternative example cross-sectional view of example zone antenna mat 520 of FIG. 8A taken along the line A-A′. FIG. 8D is an example cross-sectional view of example zone antenna mat 520 of FIG. 8A taken along the line A-A′.

As shown in FIGS. 8A-8C, example zone antenna mat 520 includes a top substrate 532, a bottom substrate 530 and an antenna layer 502 disposed between top substrate 532 and bottom substrate 530. Antenna mat 520 further includes a top surface 544 and a bottom surface 542. In some examples, as shown in FIG. 8C, bottom substrate 530 includes a recessed groove 528 sized to receive antenna layer 502, which in this example is a flat copper wire spiral antenna 504 such as that shown in FIG. 7. In other examples (not shown), top substrate 532 may include a recessed groove sized to receive antenna layer 502, and/or both top and bottom substrates may include cooperative recessed grooves sized to receive at least a portion of antenna layer 502. In other examples, as shown in FIG. 8D, antenna mat 520 further includes a middle substrate 536. The middle substrate 536 is substantially the same thickness as antenna layer 502, and acts as a spacer within which the antenna coil is flush. In this way, middle substrate 536 effectively defines a recessed groove 528′ sized to receive antenna layer 502.

In some examples, antenna layer 502 is sealed between substrates 530 and 532 (and/or 536 such as in the example of FIG. 8D) to protect and prevent damage to antenna layer 502. In examples where antenna layer 502 is received into a recessed groove 528, or in which middle substrate acts a spacer, recessed groove 528 (or 528′) may be filled with a filler material 534 such as an RTV (room temperature vulcanization) silicone or by using one or more types of adhesives, sealants, or any type of laminating technique. This may help stabilize antenna layer 502 within the recessed groove 528/528′ and between substrates 530 and 532 so as to protect antenna layer 502 from damage caused by movement of the antenna mat, forces resulting from movement of healthcare workers, hospital beds or other equipment on or over antenna mat, etc.

In some examples, zone antenna mat 520 has overall dimensions of approximately 24 inches wide by 36 inches long and approximately 0.1 inch (2.54 millimeters) thick (dimension C in FIG. 8C). However, zone antenna mat may include dimensions selected to achieve the desired antenna characteristics, and the disclosure is not limited in this respect. Top substrate 532 and/or bottom substrate 530 of zone antenna mat 520 may include, for example, any type of flexible and/or abrasion resistant polyimide or polyester film. Bottom substrate 530 of zone antenna mat 520 may alternatively or in addition include an adhesive layer or EPDM (Ethylene Propylene Diene Monomer) synthetic elastomer or other non-slip layer. In some examples, the top and/or bottom substrate of the zone antenna mat are resistant to abrasion, scratching, flexing and creasing so as to be resistant to various sources of wear typically encountered in a hospital environment or other environment such as foot traffic, abrasive or chemical cleaning products, and rolling or dragging of hospital beds or other equipment on or over zone antenna mat 520, and the like.

Similar to zone antenna mats 116/300, zone antenna mat 520 may be configured for either temporary or semi-permanent installation on a floor, wall, or other substrate. In a semi-permanent configuration, bottom substrate 530 of zone antenna mat 520 may include an adhesive layer and a release liner (not shown in FIG. 8C). Release liner is removed before adhering zone antenna mat 520 to the substrate. In a temporary configuration, bottom substrate 530 of zone antenna mat 520 may include an EPDM synthetic elastomer (e.g., synthetic rubber) or other non-slip material.

As shown in FIGS. 8A-8B, top substrate 532 may include graphics designed to aid staff members in properly orienting zone antenna mat 520 such that the detection zone established by zone antenna mat 520 is properly oriented around the physical area to be monitored. For example, zone antenna mat 520 includes the graphics “Center Bed Over Mat” and/or one or more other graphics to provide hospital staff with a visual guide as to where to place a hospital bed with respect to zone antenna mat 520. In the example antenna mat 520 shown in FIGS. 8A-8B, top substrate 532 is comprised of a clear or substantially transparent material so that antenna coil 504 is visible through the top substrate 532. However, this is for example purposes only, and the disclosure is not limited in this respect. In such examples, in addition to or alternatively to printing graphics on the top surface 532 of antenna mat, the graphics may be printed on the bottom surface 530 of antenna mat 520 as such graphics will be visible through the top surface 532 in examples where the top surface is substantially transparent.

In one example installation, one or more zone antenna mats 520 may be positioned on the floor of a hospital room, in an ICU, or in many such rooms or areas in a healthcare facility and left in place to provide a visual guide for proper placement of a patient bed (or other medical transport or patient support device such as a gurney, stretcher, wheelchair, lift, bench, exam or treatment table, procedure or reclining chair, etc.) with respect to the zone antenna mat 520. A zone beacon unit for each antenna mat 520 (or a zone beacon unit that drives multiple zone antenna mats 520) is plugged into a standard AC wall outlet, and the zone antenna mat(s) 520 connected to the zone beacon unit. Installation of the zone antenna system is simplified in that both the zone beacon unit(s) and the antenna mat(s) are installed in appropriate locations in the room rather than mounted to a patient bed or other object around which a detection zone is to be established. As one example, objects such as patient beds can be removed from a first location or room with respect to a first antenna mat/detection zone to a second location or room with respect to a second antenna mat/detection zone without requiring hospital staff to perform any adjustments (e.g., power on or off, adjust the range, etc.) to the zone beacon unit or the antenna mat. For example, a patient may be moved in their patient bed from a first location, such as their patient room, with respect to a first antenna mat/detection zone in the patient room to a second location in the healthcare facility with respect to a second antenna mat/detection zone at the second location to undergo tests or other procedures, and then returned to the first location over the first antenna mat/detection zone. In this way, detection zones can be set up in almost any desired location and remain in place (at least temporarily or on a semi-permanent basis) and the patient(s)/patient bed(s)/other object(s) moved from one detection zone to another detection zone without the need for adjustments to the zone beacon units or the antenna mats by staff members. In addition, unintentional zone entry events are not detected in hallways or other common areas, because the beacon unit/zone antenna/detection zone does not move with the patient bed, but are instead associated with an installed location.

Although a specific example antenna layer 502 and antenna coil 504 is shown and described with respect to FIGS. 7A-7C and 8A-8C for purposes of illustration, it shall be understood that the disclosure is not limited in this respect. For example, the overall dimensions, shape, layout, number of turns, conductive material, gauge of wire, material of wire, and/or method of manufacture may be varied, and the disclosure is not limited in this respect. For example, instead of copper wire, antenna coil 504 may be comprised of any type of conductive material, such as copper-covered steel, copper alloys, aluminum, nickel, silver, any other type of conductive metal or metal alloy, or combination thereof.

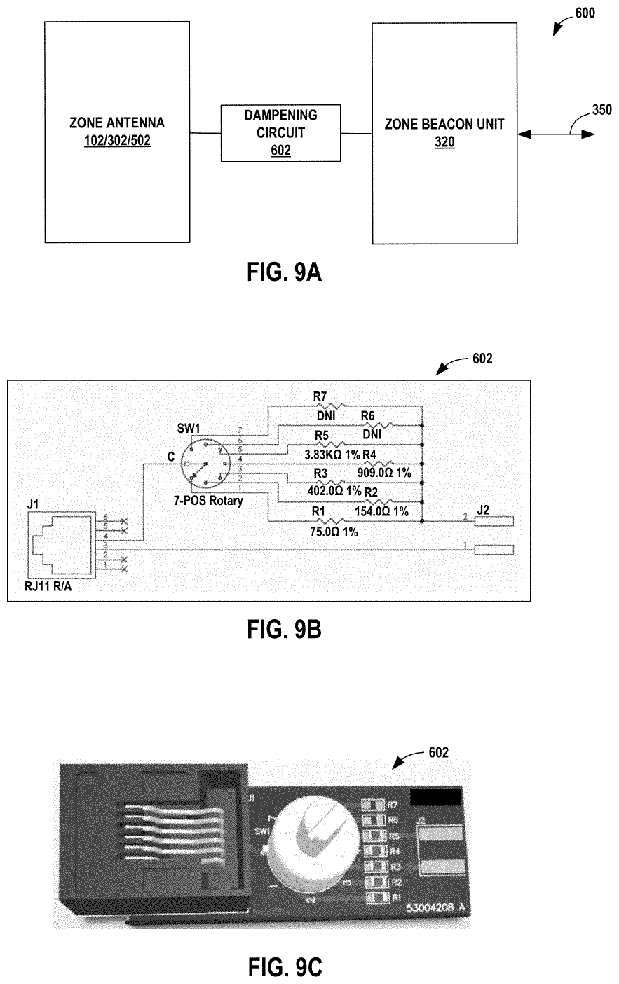

FIG. 9A is a block diagram of another example zone antenna system 600. As with zone antenna system 301 of FIG. 5, zone antenna system 600 includes a zone antenna 102/302/502 and a zone beacon unit 320. Zone antenna system 600 also includes a dampening circuit 602. In this example, dampening circuit 602 is a separate module that is optionally connected between zone beacon unit 320 and zone antenna 102/302/502. The purpose of dampening circuit 602 is to provide additional, finer grain range adjustment of the detection zone provided by zone antenna system 600 in addition to that provided by zone antenna range adjust 340 as shown in FIG. 5.

For example, for each range setting of zone antenna range adjust 340 (i.e., where each setting corresponds to a different driving voltage provided by zone beacon unit 320), dampening circuit 602 may provide multiple finer grain range adjustments. In this way, the range of the detection zone may be finely tuned to achieve a substantially similar detection zone for zone antennas installed in similar applications throughout a facility regardless of the type or amount of interference present in the different antenna environments. In a hospital or other healthcare facility, for example, it may be generally desirable to have substantially consistent detection zone ranges across all similarly situated patient beds in the facility (e.g., a patient bed in a typical patient room). When such detection zones are reliably consistent, hospital workers are able to accurately understand and predict the location of each particular detection zone around each patient bed when interacting with different patients. In addition, providing uniform detection zone ranges across the facility for each particular instance of hand hygiene behavior to be monitored also helps to ensure that hand hygiene compliance data is consistent and meaningful throughout the facility.

In some applications, depending upon the environment in which zone antenna system 100/301/600 is installed, interference present in the environment may affect the range of the detection zone that can be achieved. For example, depending upon the amount of radiation, metals, noise or other interference present in the antenna environment, the amount of gain, attenuation, and/or the radiation pattern of the detection zone can vary greatly. Thus, depending upon the antenna environment, the range of a detection zone provided by the same zone antenna driven in the same way can vary from a few inches to more than 30 feet. In some examples, where the maximum range of the detection zone is relatively high, dampening circuit 602 provides for multiple fine grain adjustment of the range of the detection zone.

In the example of FIG. 9A, dampening circuit 602 is shown as a separate module optionally connected between zone beacon unit 320 and zone antenna 102/302/502. However, in other examples, dampening circuit 602 may be integrated as part of zone beacon unit 320 or zone antenna 102/302/502. In some examples, dampening circuit 602 is optionally connected between zone beacon unit 320 and zone antenna 102/302/502 on an as needed basis as determined at the time installation. For example, if the range of the detection zone requires finer grain adjustment than can be provided by zone beacon unit 320 for a particular zone antenna in a particular installation environment, the installer may elect to connect dampening circuit 602 between zone beacon unit 320 and zone antenna 102/302/502 so as to enable more precise adjustment of the detection zone in that particular installation. On the other hand, a different zone antenna installed at the same site but in a different room, floor or area having a different radiation environment may not require dampening circuit 602 in order to achieve the desired detection zone range.

FIG. 9B shows a circuit diagram of an example dampening circuit 602 and FIG. 9C shows a rendering of an example dampening circuit 602. Example dampening circuit 602 includes one or more resistors R1-R7 of varying resistance values and a multi-position switch SW1 by which a user may adjust the range of the detection zone. Although particular resistance values are shown in FIG. 9B, these values are given for example purposes only, and the disclosure is not limited in this respect. A connector J1 provides connection to a corresponding connector to the leads of zone antenna 102/302/502 and connector J2 connects to zone beacon unit 320. Rotation of switch S1 connects the voltage applied by zone beacon unit through different resistors R1-R7, resulting in a driving voltage applied to the zone antenna 102/302/502 that is dampened (e.g., lowered) by an amount proportional to the respective resistor. In this example, switch S1 is a 7-position rotary switch that provides for seven different range adjustments; however, switch S1 is given for example purposes only, and the disclosure is not limited in this respect.

In accordance with one or more aspects of the disclosure, the term “or” may be interrupted as “and/or” where context does not dictate otherwise. Additionally, while phrases such as “one or more” or “at least one” or the like may have been used in some instances but not others, those instances where such language was not used may be interpreted to have such a meaning implied where context does not dictate otherwise.

In one or more examples, the functions described may be implemented in hardware, software, firmware, or any combination thereof. If implemented in software, the functions may be stored on or transmitted over, as one or more instructions or code, a computer-readable device or medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to non-transitory tangible computer-readable storage media. Data storage media may be any available media that can be accessed by one or more computers or one or more processors to retrieve instructions, code and/or data structures for implementation of the techniques described in the disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of the disclosure may be implemented in a wide variety of devices or apparatuses, including a wireless handset, an integrated circuit (IC) or a set of ICs (e.g., a chip set). Various components, modules, or units are described in the disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

Various examples have been described. These and other examples are within the scope of the following claims.

1. An antenna mat comprising:
a first substantially planar substrate;
a second substantially planar substrate; and
an antenna layer disposed between the first and second substantially planar substrates and configured to transmit a near-field radio frequency detection zone message within a corresponding detection zone, the antenna layer comprising a substantially planar antenna.

2. The antenna mat of claim 1, wherein the antenna layer further comprises a spiral-shaped coil antenna.

3. The antenna mat of claim 2, the antenna layer comprising a spiral-shaped coil antenna comprised of one or more layers of conductive ink and having a track width of between 0.1 and 0.3 inches and having a gap width of between 0.05 and 0.3 inches.

4. The antenna mat of claim 3, wherein the conductive ink comprises one of a conductive silver ink, a conductive silver composition ink, a conductive silver and carbon ink, a conductive carbon inks, a silver chloride ink, or a dielectric ink.

5. The antenna mat of claim 3, wherein the antenna layer is printed with the one or more layers of conductive ink.

6. The antenna mat of claim 3, wherein the antenna layer is printed by one of screen printing, ink-jet printing, pad-printing, flexography printing, or rotogravure printing.

7. The antenna mat of claim 3, wherein the antenna layer comprises between one and ten layers of conductive ink.

8. The antenna mat of claim 2, wherein the spiral-shaped coil antenna includes between 15 and 40 turns.

9. The antenna mat of claim 1, wherein the antenna layer is configured to receive power from a zone beacon unit to transmit the near-field radio frequency detection zone mes sage.

10. The antenna mat of claim 1, wherein the near-field radio frequency detection zone message is transmitted at a radio frequency between 30 and 300 kilohertz (kHz).

11. The antenna mat of claim 1, wherein the antenna layer has a transverse dimension of less than or equal to 24 inches and a longitudinal dimension of less than or equal to 32 inches.

12. The antenna mat of claim 1, wherein the first substantially planar substrate includes one of a polyimide or a polyester material.

13. The antenna mat of claim 1, wherein the second substantially planar substrate includes at least one of an adhesive layer and an EPDM (Ethylene Propylene Diene Monomer) synthetic rubber material.

14. The antenna mat of claim 1, wherein the near-field radio frequency detection zone message has a range of between 12 and 400 inches from a center of the antenna layer.

15. The antenna mat of claim 1, wherein the substantially planar antenna is comprised of two or more turns of copper wire.

16. The antenna mat of claim 1, wherein the substantially planar antenna is comprised of between 15 and 40 turns of copper wire in a racetrack configuration.

17. The antenna mat of claim 16, wherein a gap width of the substantially planar antenna is substantially zero.

18. The antenna mat of claim 16, wherein the second substantially planar substrate further includes a recessed groove sized to receive the substantially planar antenna.

19. The antenna mat of claim 16, further comprising a middle substrate forming a spacer between the first substantially planar substrate and the second substantially planar substrate and forming a recessed groove sized to receive the substantially planar antenna.

20. An antenna system comprising:
an antenna mat comprising:
a first substantially planar substrate;
a second substantially planar substrate; and
an antenna layer disposed between the first and second substantially planar substrates and configured to transmit a near-field radio frequency detection zone message, the antenna layer comprising a substantially planar antenna layer; and
a zone beacon unit configured to drive the antenna layer to transmit the near-field radio frequency detection zone message and generate a corresponding detection zone.

21. The antenna system of claim 20, wherein the near-field radio frequency detection zone message has a range of between 12 and 400 inches from a center of the antenna layer.

22. The antenna system of claim 20, wherein the zone beacon unit comprises:
one or more processors; and
one or more storage devices comprising instructions that when executed cause the one or more processors to:
control power to the antenna layer such that the antenna layer periodically transmits the near-field radio frequency detection zone message;
receive a zone presence reply message from an electronic tag present in the detection zone, the zone presence reply message including a tag address corresponding to the electronic tag;
in response to receiving the zone presence reply message, detect an entry event; and
transmit entry event data corresponding to the detected entry event.

23. The antenna system of claim 22, wherein the entry event data includes the tag address, a zone beacon unit address associated with the zone beacon unit, and a time and date of the detected entry event.

24. The antenna system of claim 20, the antenna layer further comprising a spiral-shaped coil antenna comprising one or more layers of conductive ink.

25. The antenna system of claim 24, the spiral-shaped coil antenna having a track width of between 0.1 and 0.3 inches and having a gap width of between 0.05 and 0.3 inches.

26. The antenna system of claim 24, wherein the conductive ink comprises one of a conductive silver ink, a conductive silver composition ink, a conductive silver and carbon ink, a conductive carbon inks, a silver chloride ink, or a dielectric ink.

27. The antenna system of claim 20, the antenna layer further comprising a spiral-shaped coil antenna including between 15 and 40 turns of copper wire.

28. The antenna system of claim 20, wherein the near-field radio frequency detection zone message includes a frequency between 30 and 300 kilohertz (kHz).

29. The antenna system of claim 20, wherein the antenna mat has a total thickness of between 1 and 4 millimeters.
